(19) United States
(12) Patent Application Publication
(10) Pub. No.: US 2009/0218897 A1
(43) Pub. Date: Sep. 3, 2009

(54) DAMPER

(75) Inventors: Monique Ide, Locmaria-Plouzane (FR); Dominique Annick Thomas, Areines (FR); Philippe Fernand Charles Roberge, Issy-Les-Moulineaux (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/097,055

(22) PCT Filed: Dec. 20, 2006
(86) PCT No.: PCT/EP06/69976

§ 371 Date: Oct. 1, 2008

(30) Foreign Application Priority Data
Dec. 21, 2005 (FR) 05 13024

(51) Int. Cl. H02K 7/102; H02P 3/12; H02K 7/104

(52) U.S. Cl. 310/93; 318/379

(57) ABSTRACT

The invention relates to a device for damping the movement of a movable element (1) relative to a fixed element (3). The device comprises means for generating an electric current changing with the speed of movement of the movable element (1) relative to a fixed element (3). According to the invention, the device also comprises means (20 to 25) for modifying the mechanical properties of a fluid situated between the movable element (1) and the fixed element (3) by means of the electric current. The means (4 to 7, 8, 10) for generating an electric current comprise a generator comprising a rotor (4 to 7) and a stator (8, 10), the rotor (4 to 7) being fixedly attached to the movable element (1) and the stator (8, 10) being fixedly attached to the fixed element (3). Advantageously a magnetorheological fluid, bathed in a magnetic field generated by the electric current, is used.

### CROSS-REFERENCE TO RELATED APPLICATIONS

The present Application is based on International Application No. PCT/EP2006/069976, filed on Dec. 20, 2006, which in turn corresponds to French Application No. 0513024, filed on Dec. 21, 2005, and priority is hereby claimed under 35 USC §119 based on these applications. Each of these applications are hereby incorporated by reference in their entirety into the present application.

### FIELD OF THE INVENTION

The invention relates to a damping device. The invention finds a notable utility in the damping of the movement of a movable pitch probe for an aircraft. Knowing the pitch of an aircraft relative to the air that surrounds it is crucial for flight safety notably at low speeds for example in order to detect a possible stall of the aircraft.

### BACKGROUND OF THE INVENTION

Two types of movable pitch probes are known. Vaned probes comprise a movable portion placed on the skin of the aircraft and designed to be oriented in the axis of the wind. More recent movable multifunction probes comprise pressure taps placed on the movable portion. Multifunction probes make it possible to determine in addition to the pitch, the total pressure and the static pressure of the wind. Movable multifunction probes have a greater inertia than vaned probes. The response time of these probes must be short and the probe must be well damped to prevent overshoots and even oscillations in order to prevent an inadvertent detection of a stall. For example, certain military aircraft have an armament placed in a “pod”, that is to say under the wings of the aircraft. Firing this armament creates considerable aerodynamic turbulence. Specifically, the wake during firing represents a significant pitch level for the probes of the aircraft. Poor damping risks abutment and damaging the movable portion of the probes. The greater the weight of the movable portion of the probe, the more critical the quality of damping. The invention will therefore find a particularly worthwhile application for multifunction probes whose movable portions are heavier than those of the vaned probes.

To damp the movement of the movable portion of the probes, three damping principles are known:

Pneumatic damping with air throttling. This principle is costly and bulky because it is mechanically complex to implement. In addition, air pollution reduces its reliability.

Electromagnetic damping. This principle is very reliable irrespective of the temperature of the probe. On the other hand, it has a low damping coefficient, it is bulky and costly in its implementation. It also has a high inertia.

Fluid damping. This principle takes up little space and is not very costly to implement. Its inertia is low. On the other hand, the damping that it provides is very variable depending on the temperature. Its implementation therefore often requires a thermostatically controlled environment.

### SUMMARY OF THE INVENTION

The object of the invention is to alleviate the defects of the dampers described above by coupling an electromagnetic damper and a brake using a magneto- or electrorheological fluid such as for example described in U.S. Pat. No. 6,547,986 in order to create a viscous damper.

Accordingly, the subject of the invention is a device for damping the movement of a movable element relative to a fixed element, the device comprising means for generating an electric current changing with the speed of movement of the movable element relative to the fixed element, characterized in that it also comprises means for modifying the mechanical properties of a fluid situated between the movable element and the fixed element by means of the electric current and in that the means for generating an electric current comprise a generator comprising a rotor and a stator, the rotor being fixedly attached to the movable element and the stator being fixedly attached to the fixed element.

The electromagnetic damper forms the generator modifying the mechanical properties of the fluid. Therefore, the device is self-sufficient; it requires no external energy source to operate. It is the movement of the movable element that generates the energy necessary to modify the mechanical properties of the fluid.

The invention can be used to damp an oscillating movement or to brake a nonoscillating movement. The invention is advantageously implemented in a vehicle retarder for example installed in heavy goods vehicles. Specifically, the modification of the mechanical properties of the fluid makes it possible to create mechanical links between the movable element and the fixed element making it possible to brake the movable element according to its speed.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents a device rotating about an axis, in a section perpendicular to this axis;

FIG. 2 represents the device of FIG. 1, in section in a plane containing the axis of rotation.

For the purposes of clarity, the same elements will bear the same reference numbers in the various figures.

### DETAILED DESCRIPTION OF THE PREFERRED EMBODIMENT

The device shown in the figures comprises a movable element 1 in rotation about an axis 2 relative to a fixed element 3. The rotary movement is given only as an example and it is well understood that the invention may be implemented for other movements such as a translation movement. In the example in question, the movable element is called a rotor 1 and the fixed element is called a stator 3.

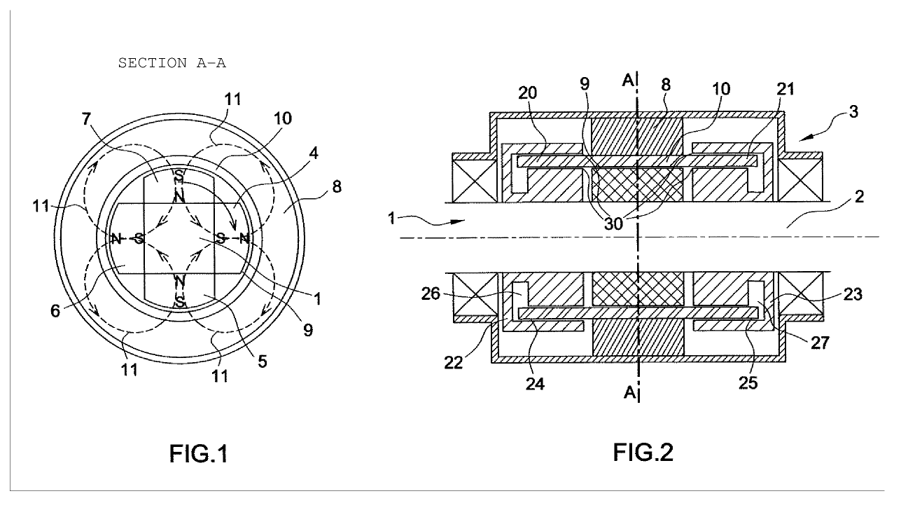

The device comprises means for generating an electric current changing with the speed of movement of the rotor 1 relative to the stator 3. The change of the electric current is for example an increasing change of the type proportional to the speed. More precisely, the rotor 1 comprises at least one permanent magnet. In the example shown, the rotor 1 comprises four permanent magnets 4 to 7. The magnets 4 to 7 are oriented radially about the axis 2. The stator 3 comprises a magnetic casing 8 surrounding the magnets 4 to 7. The magnets 4 to 7 and the casing are separated by an air gap 9. A ring 10, fixedly attached to the casing 8 and made of amagnetic material, is placed in the air gap 9. The ring 10 is made of an electrically conductive material such as for example a copper alloy. The magnets 4 to 7 each comprise two poles marked N and S in FIG. 1. The magnets 4 to 7 are oriented so that the poles follow one another alternately N then S in the air gap 9. Magnetic field lines 11 are formed between two successive poles in the air gap 9. The magnetic field lines 11 are closed by the casing 8 and by the axis 1. When the rotor 1 moves relative to the stator 3, an electric current is generated in the ring 10. The electric current is proportional to the speed of rotation of the rotor 1 relative to the stator 3. The magnets 4 to 7, the casing 8 and the ring 10 form the means for generating an electric current.

They also form an electromagnetic damper. This damper could be sufficient on its own to fulfill the function of damping the movement of the rotor 1 relative to the stator 3. In the invention, the electromagnetic damper is intentionally undersized. It provides only a small portion of the necessary damping, of the order of a few percent. Its main function is to generate an electric current proportional to the speed of the rotor. The current is furthermore used to supplement the damping.

Accordingly, the device also comprises means for modifying the mechanical properties of a fluid situated between the rotor 1 and the stator 3 according to the electric current. Advantageously, the ring 10 comprises at least one extension along the axis 1 beyond the casing 8. In the example shown, the ring 10 comprises two extensions 20 and 21 extending along the axis 2, one on each side of the casing 8. The extensions 20 and 21 each form with a hoop, respectively 22 and 23, an interstice respectively 24 and 25 in which the fluid is situated. The hoops 22 and 23 are fixedly attached to the rotor 1. The hoops 22 and 23 have a shape of revolution about the axis 2. In a particular arrangement, each hoop 22 and 23 comprises a circular groove in which an extension 20 or 21 of the ring 10 slides. The interstices 24 and 25 are formed between the inner walls of the grooves and the extensions 20 and 21. Therefore, each interstice 24 or 25 is double and this makes it possible to increase the surface areas facing the hoop 22 or 23 with the corresponding extension 20 or 21. If, on the other hand, the user does not desire to increase the facing surface areas, it makes it possible, at an equivalent surface area, to obtain a lap of the associated interstice 24 or 25 and to improve the compactness of the device.

Advantageously, the fluid is a magnetorheological fluid and the electric current generates a magnetic field in the fluid. The fluid used comprises magnetic particles in colloidal suspension in a solvent such as for example water or silicone-based oil. The presence of fluid in the interstices 24 and 25 generates a resistant torque when the rotor 1 rotates. The resistant torque would be a function only of the viscosity of the fluid if no current ran in the ring 10. The presence of a current running in the ring 10 generates a magnetic field in the interstices 24 and 25. Along the field lines, the magnetic particles agglomerate to form mechanical connections between an extension 20 or 21 and the corresponding hoop 22 or 23. The stiffness of the mechanical connections is a function of the intensity of the magnetic field, therefore of the current running in the ring 10 and therefore of the speed of movement of the rotor 1 relative to the stator 3. The extensions 20 and 21 and the corresponding hoops 22 and 23 form a magnetorheological brake whose resistant torque is a function of the shearing of the mechanical connections formed by the agglomeration of the magnetic particles. To obtain great efficiency of the damping device, the user seeks to generate in the ring 10 the most intense electric currents possible. To do this, the ring 10 is made of a not very resistive material such as for example a copper alloy.

It would be equally possible to use an electrorheological fluid. In this case, the arrangement of the interstice is such that the fluid is subjected to an electric field generated by the electric current. In this case, to enhance the effectiveness of the damping device, it is necessary to increase the voltage between the ring 10 and the hoops 22 and 23. Accordingly, it is possible to produce a ring 10 in a resistive material or replace the ring 10 by windings whose extensions (similar to the extensions 20 and 21) are formed by the chignons of the windings. It is well understood that the use of windings is also possible by using a magnetorheological fluid. It has nevertheless been noted that the response time of a magnetorheological fluid was weaker than that of an electrorheological fluid. The use of a magnetorheological fluid therefore seems better suited to the production of a viscous damping device.

Advantageously, each interstice 24 and 25 opens onto a reservoir of fluid, respectively 26 and 27, made in the corresponding hoop 22 or 23. More precisely, each reservoir is made in the bottom of each groove. The reservoirs 26 and 27 make it possible to supply the interstices 24 and 25 with fluid in the case of practically inevitable leakages during a prolonged operation. The existence of the reservoirs 26 and 27 makes it possible to increase the weight of fluid and the surface areas of heat exchange between the rotor 1 and the stator 3. Therefore the energy dissipated by friction may easily be cleared via the axis 2 of the rotor 1.

5 Advantageously, at least one zone 30 of the hoops 22 and 23 is treated to prevent the fluid from leaving the corresponding interstice 24 and 25. In the example shown, four zones 30 situated at the ends of the walls of the two grooves are treated to repulse the fluid toward the corresponding interstice 23 and 24. This treatment is for example a water repellent treatment. It makes it possible to limit the fluid leakages during an extended use of the damping device.

Advantageously, a distance marked “d” separating the permanent magnets 4 to 7 and the hoops 22 and 23 is defined so as to limit the effect of leakage lines in the air gap 9 on the fluid. The distance d is measured along the axis 2. Specifically, in the absence of movement of the rotor 1, the field lines 15 formed by the permanent magnets 4 to 7 are closed by the casing and may overflow from the air gap 9 as far as crossing the interstices 24 and 25. If the fluid is subjected to such a magnetic field, even in the absence of movement of the rotor 1, the magnetorheological brake generates a resistant torque similar to a dry friction that is usually undesirable in a damping device.

Advantageously, the device comprises means for adjusting the modification of the mechanical properties of the fluid according to the intensity of the electric current. The distance d also makes it possible to adjust the modification of the mechanical properties of the fluid according to the intensity of the electric current and consequently to regulate the damping of the device. More precisely, by increasing the distance d, the user reduces the effect of the current on the fluid and therefore reduces the resistant torque of the magnetorheological brake. Another possibility for adjusting the modification of the mechanical properties of the fluid consists, in the case of using windings in place of the ring 10, in producing connections in the windings. It is possible for example to have several windings and to open the circuit of some in order to reduce the damping of the device.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A device for damping the movement of a movable element relative to a fixed element, the device comprising means for generating an electric current changing with the speed of movement of the movable element relative to the fixed element, means for modifying the mechanical properties of a fluid situated between the movable element and the fixed element by means of the electric current wherein the means for generating an electric current comprise a generator comprising a rotor and a stator, the rotor being fixedly attached to the movable element and the stator being fixedly attached to the fixed element.

2. The device as claimed in claim 1, wherein the fluid is a magnetorheological fluid and wherein the electric current generates a magnetic field in the fluid.

3. The device as claimed in claim 1, wherein the movement of the movable element is a movement of rotation about an axis.

4. The device as claimed in claim 3, wherein a first element comprises at least one permanent magnet, the second element comprises a magnetic casing, the magnet and the casing are separated by an air gap, a ring made of amagnetic material and electrically conductive is placed in the air gap fixedly attached to the casing.

5. The device as claimed in claim 4, wherein the ring comprises at least one extension along the axis beyond the casing, the extension forms, with a hoop fixedly attached to the first element, an interstice in which the fluid is situated.

6. The device as claimed in claim 5, wherien the hoop comprises a circular groove in which the extension of the ring slides.

7. The device as claimed in claim 5, wherein the interstice opens onto a reservoir of fluid made in the hoop.

8. The device as claimed in claim 5, wherein at least one zone of the hoop is treated to prevent the fluid from leaving the interstice.

9. The device as claimed in claim 5, wherein a distance separating the permanent magnet and the hoop is defined so as to limit the effect of leakage lines in the air gap on the fluid.

10. The device as claimed in claim 5, wherein it comprises means for adjusting the modification of the mechanical properties of the fluid according to the intensity of the electric current.
